(19) United States
(12) Patent Application Publication
(10) Pub. No.: US 2026/0008306 A1
(43) Pub. Date: Jan. 8, 2026

(54) ADJUSTABLE VEHICLE TRACTOR

(71) Applicant: SHENZHEN YATU TRADING CO., LTD., SHENZHEN (CN)

(72) Inventor: HONGLI WEI, SHENZHEN (CN)

(73) Assignee: SHENZHEN YATU TRADING CO., LTD., SHENZHEN (CN)

(21) Appl. No.: 18/765,176

(22) Filed: Jul. 5, 2024

(51) Int. Cl. B60D 1/46; B60D 1/06

(52) U.S. Cl. CPC B60D 1/46; B60D 1/065

(57) ABSTRACT

The present invention relates to the field of tractors, comprising: in the process of adjusting the sliding support head by the vehicle tractor, the user needs to unscrew the locking bolt, so that the front end of the locking bolt is separated from the locking screw hole of the vertical adjusting end. The friction force between the sliding support head and the vertical adjusting end can be reduced, so that the sliding support head can slide more easily; on the other hand, the talcum powder located in the talcum powder cylinder is attached to the surface of the roller, so that a layer of thin film can be formed between the contact surface of the vertical adjusting end and the sliding support head, so that the movement is smoother, and the abrasion generated by the vertical adjusting end and the sliding support head in the subsequent traction process is protected.

### TECHNICAL FIELD

The present disclosure relates to the field of tractors, and in particular, to an adjustable vehicle tractor.

### BACKGROUND

As the living level of people is continuously increased, a part of people warm the vehicle to obtain additional fun, and the tractor is modified to one of them, the tractor is one of the accessories of the vehicle, and one vehicle is mainly made to bind the pull rope to the tractor of the other vehicle to drive the other vehicle to move.

According to Chinese Authorization Patent Publication No.CN214355390U, the disclosed adjustable vehicle tractor includes a head, a string, a hook base plate, a connecting shaft, and a lock for driving the connecting shaft to move in the axial direction of the connecting shaft; the pulling hook bottom plate is slidably connected with the supporting head, and the pulling hook bottom plate is provided with at least two grooves communicated with each other; one end of the connecting shaft penetrates into the supporting head and penetrates through the rope column, and the other end of the connecting shaft is matched with the groove; and one end of the lock extends into the supporting head to be connected with the connecting shaft. In the present utility model, up-down adjustment of the tractor can be well achieved, so that the pull rope is parallel to the ground as much as possible in the vertical plane, thereby efficiently utilizing the power of one vehicle to pull another vehicle to move, but in the traction process, the friction force between the sliding support and the vertical adjustment end may cause difficulty in operation, a greater amount of force is required to be adjusted up and down, the labor intensity of the user is increased, the sliding position connected up and down is easy to wear during long-term use, and the service life of the tractor is shortened.

### SUMMARY

In view of the deficiencies of the prior art, the present invention provides an adjustable vehicle tractor, which solves the problems that in the traction process, the friction force between the sliding support head and the vertical adjusting end may be difficult to operate, a larger amount of force is needed to be adjusted up and down, the labor intensity of the user is increased, the sliding position connected up and down is prone to abrasion in the long-term use process, and the service life of the tractor is shortened.

In order to achieve the above objective, the present invention is implemented by the following technical solutions: an adjustable vehicle tractor, comprising:
a traction connecting arm, wherein the front end of the traction connecting arm is inserted into the tail insertion end of the trailer, and the traction connecting arm comprises a tail connecting end, a vertical adjusting end, a side sliding groove and a locking screw hole;
a traction adjustment mechanism, disposed on a rear side of the traction connection arm and configured to implement up-down position adjustment;
a connection protection mechanism, disposed on an inner side of the sliding support head in the traction adjustment mechanism, and configured to implement traction sliding protection;

The anti-shaking mechanism is disposed inside the traction connecting arm and configured to prevent the vehicle tractor from shaking after installation.

Preferably, a vertical adjusting end is fixedly connected to the lower end of the rear side of the tail connecting end, and side sliding grooves are formed in the left side and the right side of the vertical adjusting end.

Preferably, the traction adjusting mechanism comprises a sliding support head, a threaded cylinder, a locking bolt, a protruding anti-falling end, an inner side groove and a bolt pad, the sliding support head is slidably connected to the rear side of the vertical adjusting end, the left end and the right end of the front side of the sliding support head are embedded in the two side sliding grooves of the vertical adjusting end, and the inner side grooves are formed in the two sides of the interior of the rear side of the sliding support head.

Preferably, the connection protection mechanism comprises a talcum powder cylinder, a connecting shaft, a roller, a sliding arm, a connecting pad, a damper and a buffer spring, the roller is arranged in the inner side groove, a talcum powder cylinder is fixedly connected to the surface of the inner wall of the front side of the inner side groove, in the process of moving up and down on the sliding support head, the roller located in the inner side groove of the sliding support head rotates under the friction effect of the sliding position of the sliding support head and the vertical adjusting end, and after the roller rotates, the friction force between the sliding support head and the vertical adjusting end can be reduced, the talcum powder is attached to the surface of the roller, and as the sliding support moves, the talcum powder is attached to the tiny gap between the vertical adjusting end and the sliding support, the talcum powder has a smooth feeling, a layer of thin film can be formed between the contact surface of the vertical adjusting end and the sliding support, the friction force of the object during relative movement is reduced, the movement is smoother, the abrasion generated in the subsequent traction process of the vertical adjusting end and the sliding support is protected, and the service life of the tractor is prolonged.

Preferably, both sides of the talcum powder cylinder are fixedly connected with fixing pads, the outer sides of the two fixing pads are provided with dampers, the fixed ends of the dampers are fixedly connected with the fixing pad, the free end of the damper is fixedly connected with a connecting pad, the outer side of the damper is sleeved with a buffer spring, and since the roller can move in the left-right direction along with the sliding arm, the transverse swing force generated in the subsequent vehicle traction process can enable the roller to generate displacement in the left-right direction, and the roller counteracts the impact through the damper and the buffer spring while moving along with the sliding arm to protect the tractor.

Preferably, the connecting pad is fixedly connected to the outer side of the sliding arm, and the front end of the sliding arm is arranged inside the talcum powder cylinder in a penetrating manner.

Preferably, a connecting shaft is rotatably connected to the inner side of the connecting pad, a roller is fixedly connected to the end, away from the connecting pad, of the connecting shaft, and one side of the roller is embedded in the talcum powder cylinder.

Preferably, a powder adding plug is arranged above the sliding support, and the lower end of the powder adding plug is arranged inside the talcum powder cylinder in a penetrating manner.

The upper surface of the fixing sleeve is fixedly connected with an upper ball head. The lower surface of the fixing sleeve is fixedly connected with a lower ball head. The upper ball head and the lower ball head are arranged on the upper surface and the lower surface of the sliding support respectively. A threaded cylinder is transversely arranged in the middle of the fixing sleeve in a penetrating mode.

Preferably, the anti-shaking mechanism comprises a hole groove, a threaded pipe and a clamping bolt, the hole groove is transversely formed in the tail connecting end, a threaded pipe is arranged in the hole groove, the threaded pipe is fixedly connected with the tail connecting end, and a clamping bolt is in threaded connection with the interior of the threaded pipe.

### Beneficial Effects

The present invention provides an adjustable vehicle tractor. Compared with the prior art, the present invention has the following beneficial effects:
1. In the present invention, in the process of adjusting the sliding support head by the vehicle tractor, the user needs to unscrew the locking bolt, so that the front end of the locking bolt is disengaged from the locking screw hole of the vertical adjusting end, and in the process of moving up and down on the sliding support head, the friction force between the sliding support head and the vertical adjusting end can be reduced, so that the sliding support head can slide more easily, and on the other hand, the talcum powder located in the talcum powder cylinder is attached to the surface of the roller, and moves along with the sliding support head, the talcum powder has a smooth feeling, a thin film can be formed between the vertical adjusting end and the contact surface of the sliding support, the friction force generated during the subsequent traction of the object is reduced, the movement is smoother, the transverse swing force generated in the subsequent traction process of the vehicle can make the roller generate displacement in the left-right direction, and the roller counteracts the impact through the damper and the buffer spring while moving along with the sliding arm to protect the tractor;
2. In the present invention, when the vehicle tractor is used, the lower end of the vertical adjusting end passes through the sliding bracket, so that the two sides of the sliding bracket are embedded in the side sliding grooves on both sides of the vertical adjusting end, at this time, the position of the sliding bracket and the vertical adjusting end can be adjusted up and down, then the locking bolt is inserted into the threaded cylinder, and the front end of the locking bolt is screwed into the locking screw hole at the rear side of the vertical adjusting end, so that the distribution of the traction force on the vehicle chassis can be changed, thereby optimizing the action point of the traction force on the vehicle and reducing the impact on the wheel and the suspension system;
3. In the present invention, by arranging the anti-shaking mechanism, the bolt is tightened in the tail connecting hole at the tail connecting end of the insertion end of the tail of the trailer, so that the vehicle tractor is installed at the tail of the trailer, in order to prevent the vehicle tractor from shaking, the user can use the hexagonal wrench to screw the clamping bolt located in the hole groove in the tail connecting end, so that the front end of the clamping bolt is tightly pressed at the bolt position of the inserted connecting hole, so that the inserted bolt is reinforced, and the stability of the vehicle tractor is further improved.

### BRIEF DESCRIPTION OF THE DRAWINGS

FIG. 1 shows a schematic structural diagram after an insertion prompting mechanism in an adjustable vehicle tractor is removed according to the present disclosure;

FIG. 2 shows a schematic structural diagram of a rear side of an adjustable vehicle tractor according to the present disclosure;

FIG. 3 shows a schematic structural diagram of a front side of an adjustable vehicle tractor according to the present disclosure;

FIG. 4 shows a schematic structural diagram of an interface conversion mechanism in an adjustable vehicle tractor according to an embodiment of the present disclosure;

FIG. 5 shows a schematic structural diagram of an interface conversion mechanism in an adjustable vehicle tractor according to an embodiment of the present disclosure, wherein the interface conversion mechanism is inclined below a rear angle;

FIG. 6 shows a schematic structural diagram of a traction rear arm in an adjustable vehicle tractor according to the present disclosure;

FIG. 7 shows a schematic cross-sectional structural diagram of a traction connecting arm in an adjustable vehicle tractor according to the present disclosure.

Description of figures: 1—a traction connecting arm; 101—a tail connecting end; 102—a vertical adjusting end; 103—a side sliding groove; 104—a locking screw hole; 2—a traction adjusting mechanism; 201—a sliding support head; 202—a threaded cylinder; 203—a locking bolt; 204—a protruding anti-falling end; 205—an inner side groove; 206—a bolt pad; 3—connecting protection mechanism; 301—talcum powder cylinder; 302—connecting shaft; 303—roller; 304—sliding arm; 305—connecting pad; 306—damper; 307—buffer spring; 308—fixing pad; 309—powder adding plug; 4—upper ball head; 5—lower ball head; 6—fixing sleeve; 7—tail connecting hole; 8—anti-shaking mechanism; 801—hole groove; 802—threaded pipe; 803—clamping bolt.

### DETAILED DESCRIPTION

The technical solutions in the embodiments of the present disclosure will be clearly and completely described below with reference to the accompanying drawings in the embodiments of the present disclosure. All other embodiments obtained by a person of ordinary skill in the art based on the embodiments of the present invention without creative efforts shall fall within the protection scope of the present invention.

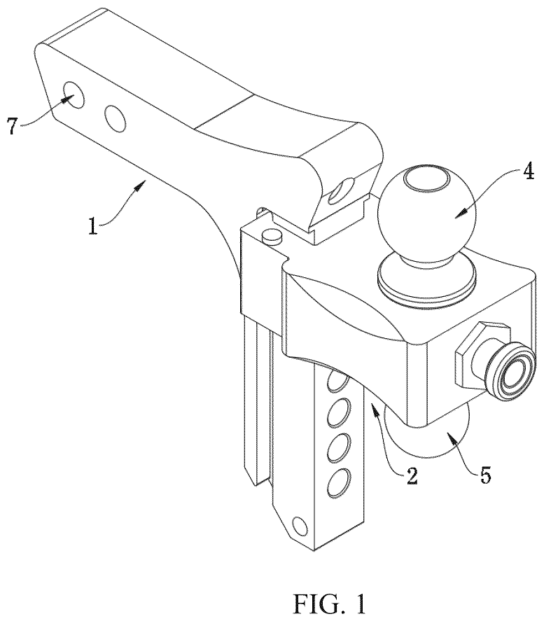

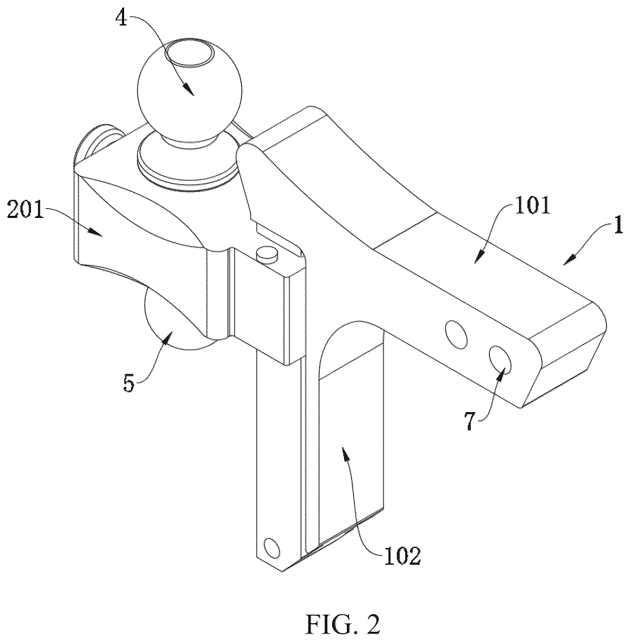

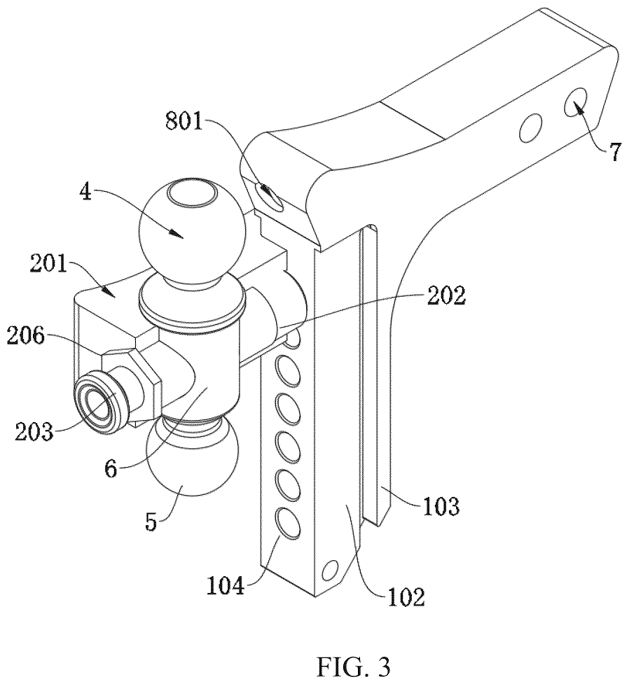

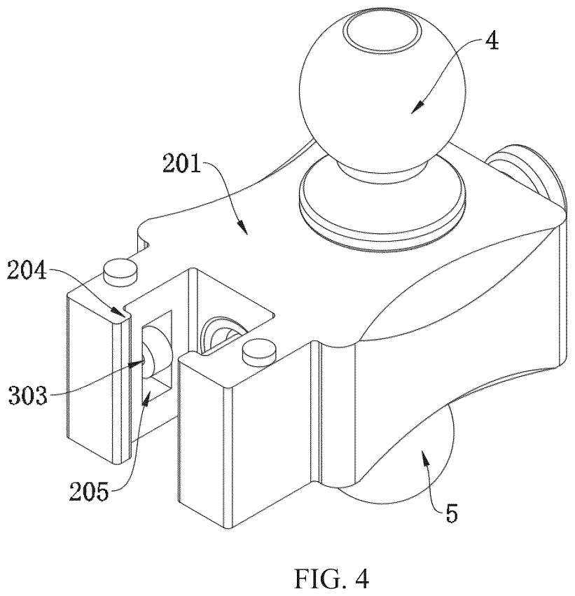

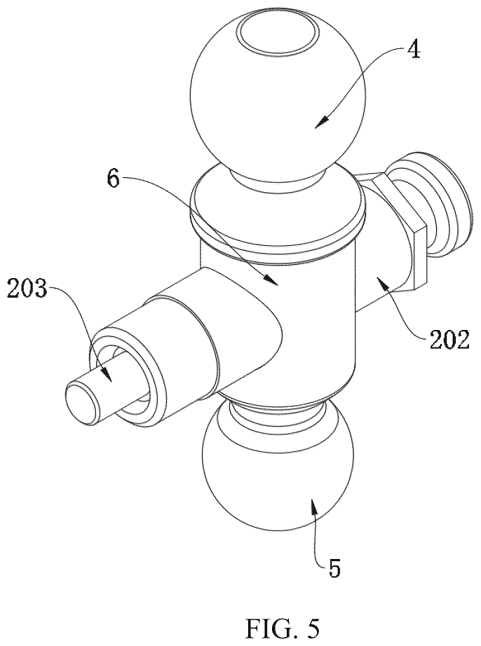

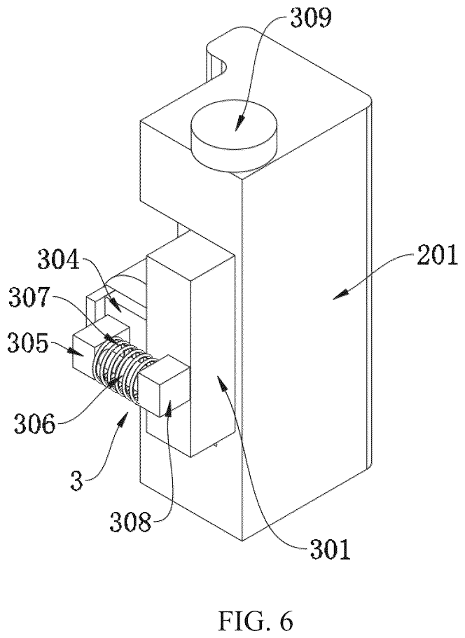

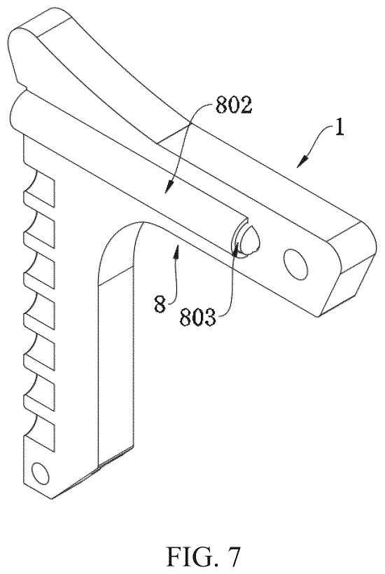

Referring to FIG. 1 to FIG. 7, the present disclosure provides two technical solutions, including the following embodiments:

### Embodiment I

An adjustable vehicle tractor includes:
the traction connecting arm 1 comprises a tail connecting end 101, a vertical adjusting end 102, a side sliding groove 103 and a locking screw hole 104; the lower end of the rear side of the tail connecting end 101 is fixedly connected with a vertical adjusting end 102; side sliding grooves 103 are formed in the left side and the right side of the vertical adjusting end 102; before the vehicle tractor is used, the front end of the traction connecting arm 1 is inserted into an insertion end interface of the tail of the trailer, and bolts are tightened in the tail connecting hole 7 of the insertion end interface side screw hole of the tail of the trailer and the tail connecting hole 7 of the tail connecting end 101, so that the vehicle tractor is installed at the tail of the trailer;
the traction adjusting mechanism 2 is arranged on the rear side of the traction connecting arm 1 and used for achieving up-down position adjustment, the traction adjusting mechanism 2 comprises a sliding support head, a threaded cylinder 202, a locking bolt 203, a protruding anti-falling end 204, an inner side groove 205 and a bolt pad 206, the sliding support head is slidably connected to the rear side of the vertical adjusting end 102, the left end and the right end of the front side of the sliding support head are embedded in the two side sliding grooves 103 of the vertical adjusting end 102, and the inner side grooves 205 are formed in the two sides of the interior of the rear side of the sliding support head;
the connecting protection mechanism 3 comprises a talcum powder cylinder 301, a connecting shaft 302, a roller 303, a sliding arm 304, a connecting pad 305, a damper 306 and a buffer spring 307, the roller 303 is arranged inside the inner side groove 205, the surface of the inner wall of the front side of the inner side groove 205 is fixedly connected with a talcum powder cylinder 301, both sides of the talcum powder cylinder 301 are fixedly connected with fixing pads 308, the outer sides of the two fixing pads 308 are provided with dampers 306, A fixing end of the damper 306 is fixedly connected to the fixing pad 308, a free end of the damper 306 is fixedly connected to a connecting pad 305, an outer side of the damper 306 is sleeved with a buffer spring 307, the connecting pad 305 is fixedly connected to an outer side of the sliding arm 304, a front end of the sliding arm 304 is disposed inside the talcum powder cylinder 301 in a penetrating manner, a connecting shaft 302 is rotatably connected to an inner side of the connecting pad 305, a roller 303 is fixedly connected to an end of the connecting shaft 302 away from the connecting pad 305, A layer of thin film can be formed between the vertical adjusting end 102 and the contact surface of the sliding support head, so that the friction force of the object during relative movement is reduced, the movement is smoother, the abrasion generated in the subsequent traction process of the vertical adjusting end 102 and the sliding support head is protected, the service life of the traction device is prolonged, a powder adding plug 309 is arranged above the sliding support head, and the lower end of the powder adding plug 309 is arranged inside the talcum powder cylinder 301 in a penetrating manner.
the anti-shaking mechanism 8 comprises a hole groove 801, a threaded pipe 802 and a clamping bolt 803, the hole groove 801 is transversely formed in the tail connecting end 101, a threaded pipe 802 is arranged in the hole groove 801, the threaded pipe 802 is fixedly connected with the tail connecting end 101, a clamping bolt 803 is in threaded connection with the interior of the threaded pipe 802, In order to prevent the vehicle tractor from shaking, the user can use the hexagonal wrench to screw the clamping bolt 803 located in the hole groove 801 in the tail connecting end 101, so that the front end of the clamping bolt 803 is tightly pressed at the bolt position of the inserted connecting hole, thereby playing a role in reinforcing the inserted bolt, and further improving the stability of the vehicle tractor.

In the process that the adjustable vehicle tractor is not used, in the process of adjusting the sliding support head by the vehicle tractor, the user needs to unscrew the locking bolt 203, so that the front end of the locking bolt 203 is separated from the locking screw hole 104 of the vertical adjusting end 102, at this time, the position of the sliding support head can be adjusted up and down, in the process of moving up and down on the sliding support head, under the friction effect of the sliding position of the sliding support head and the vertical adjusting end 102, the roller 303 located in the inner side groove 205 of the sliding support head rotates, On the one hand, the friction force between the sliding support and the vertical adjusting end 102 can be reduced, so that the sliding support can slide more easily, and on the other hand, the talcum powder located in the talcum powder cylinder 301 is attached to the surface of the roller 303, and as the sliding support moves, the talcum powder is attached to the small gap between the vertical adjusting end 102 and the sliding support, and as the roller 303 can move in the left-right direction along with the sliding arm 304, The lateral swing force generated during subsequent vehicle traction may cause the roller 303 to generate displacement in the left-right direction, and while the roller 303 is displaced along with the sliding arm 304, the roller 303 counteracts the impact by the damper 306 and the buffer spring 307 to protect the tractor. In one embodiment.

### Embodiment II

On the basis of the first embodiment, a fixing sleeve 6 is longitudinally arranged in the middle of the sliding support in a penetrating manner, the fixing sleeve 6 is fixedly connected with the sliding support, an upper ball head 4 is fixedly connected to the upper surface of the fixing sleeve 6, a lower ball head 5 is fixedly connected to the lower surface of the fixing sleeve 6, For example, the upper ball head 4 and the lower ball head 5 are respectively arranged on the upper and lower surfaces of the sliding bracket, the threaded cylinder 202 is transversely arranged in the middle of the fixed sleeve 6 in a penetrating manner, the middle of the threaded cylinder 202 is in threaded connection with the locking bolt 203, the front end of the locking bolt 203 is in threaded connection with the interior of the locking screw hole 104, the locking screw hole 104 is formed in the rear side of the vertical adjusting end 102, the number of the locking screw holes 104 is multiple, and the multiple locking screw holes 104 are distributed at equal intervals on the rear side of the vertical adjusting end 102.

In operation, when the vehicle tractor is used, the lower end of the vertical adjusting end 102 passes through the sliding support, so that the two sides of the sliding support are embedded in the side sliding grooves 103 on both sides of the vertical adjusting end 102, then the locking bolt 203 is inserted into the threaded cylinder 202, and the front end of the tightening locking bolt 203 is screwed into the locking screw hole 104 on the rear side of the vertical adjusting end 102, so that the distribution of the traction force on the vehicle chassis can be changed, thereby optimizing the action point of the traction force on the vehicle and reducing the impact on the wheel and the suspension system.

The above are only preferred embodiments of the present application and are not intended to limit the present application, and any modifications, equivalent replacements and improvements made within the spirit and principle of the present application shall fall within the protection scope of the present application.

What is claimed is:

1. An adjustable vehicle tractor, comprising:
a traction connecting arm (1), a front end thereof being inserted into a trailer tail insertion end, and the traction connecting arm (1) comprising a tail connecting end (101), a vertical adjusting end (102), a side sliding groove (103) and a locking screw hole (104);
a traction adjustment mechanism (2), disposed on a rear side of the traction connection arm (1) and configured to implement up-down position adjustment;
a connection protection mechanism (3), disposed on an inner side of a sliding support head (201) in the traction adjustment mechanism (2), and configured to implement traction sliding protection; and
an anti-shaking mechanism (8), which is arranged inside the traction connecting arm (1) and is used for preventing the vehicle tractor from shaking after being mounted.

2. The adjustable vehicle tractor according to claim 1, wherein the vertical adjusting end (102) is fixedly connected to the lower end of the rear side of the tail connecting end (101), and side sliding grooves (103) are formed in the left side and the right side of the vertical adjusting end (102).

3. The adjustable vehicle tractor according to claim 1, wherein the traction adjusting mechanism (2) comprises a sliding supporting head (201), a threaded cylinder (202), a locking bolt (203), a protruding anti-falling end (204), an inner side groove (205) and a bolt pad (206), the sliding supporting head (201) is slidably connected to the rear side of the vertical adjusting end (102), the left end and the right end of the front side of the sliding supporting head (201) are embedded in the two side sliding grooves (103) of the vertical adjusting end (102), and inner side grooves are formed in the two sides of the interior of the rear side of the sliding supporting head (201).

4. The adjustable vehicle tractor according to claim 1, wherein the connection protection mechanism (3) comprises a talcum powder cylinder (301), a connecting shaft (302), a roller (303), a sliding arm (304), a connecting pad (305), a damper (306) and a buffer spring (307), the roller (303) is arranged inside the inner side groove (205), and a talcum powder cylinder is fixedly connected to the inner wall surface of the front side of the inner side groove (205).

5. The adjustable vehicle tractor according to claim 4, wherein fixing pads (308) are fixedly connected to two sides of the talcum powder cylinder (301), dampers (306) are arranged on the outer sides of the two fixing pads (308), a fixed end of the damper (306) is fixedly connected to the fixing pad (308), a free end of the damper (306) is fixedly connected to a connecting pad (305), and a buffer spring is sleeved on an outer side of the damper (306).

6. The adjustable vehicle tractor according to claim 5, wherein the connecting pad (305) is fixedly connected to the outer side of the sliding arm (304), and the front end of the sliding arm (304) is arranged inside the talcum powder cylinder (301) in a penetrating manner.

7. The adjustable vehicle tractor according to claim 5, wherein the connecting shaft (302) is rotatably connected to the inner side of the connecting pad (305), the roller (303) is fixedly connected to the end, away from the connecting pad (305), of the connecting shaft (302), and one side of the roller (303) is embedded in the talcum powder cylinder (301).

8. The adjustable vehicle tractor according to claim 3, wherein a powder adding plug (309) is arranged above the sliding support head (201), and a lower end of the powder adding plug (309) is arranged inside the talcum powder cylinder (301) in a penetrating manner.

9. The adjustable vehicle tractor according to claim 3, wherein the upper surface of a fixing sleeve (6) is fixedly connected with an upper ball head (4), the lower surface of the fixing sleeve (6) is fixedly connected with a lower ball head (5), the upper ball head (4) and the lower ball head (5) are respectively arranged on the upper surface and the lower surface of the sliding support head (201), the threaded cylinder (202) is transversely arranged in the middle of the fixing sleeve (6) in a penetrating mode, the middle of the threaded cylinder (202) is in threaded connection with the locking bolt (203), the front end of the locking bolt (203) is in threaded connection with the interior of the locking screw hole (104), the locking screw hole (104) is formed in the rear side of the vertical adjusting end (102), and the number of the locking screw holes (104) is multiple.

10. The adjustable vehicle tractor according to claim 1, wherein an anti-shaking mechanism (8) comprises a hole groove (801), a threaded pipe (802) and a clamping bolt (803), the hole groove (801) is transversely formed in the tail connecting end (101), the threaded pipe (802) is arranged in the hole groove (801), the threaded pipe (802) is fixedly connected with the tail connecting end (101), and a clamping bolt (803) is in threaded connection with the interior of the threaded pipe (802).
